(19) United States
(12) Patent Application Publication
(10) Pub. No.: US 2018/0279640 A1
(43) Pub. Date: Oct. 4, 2018

(54) Temperature Tolerant Chocolate Spread or Filling and Method of Preparation

(71) Applicant: Loders Croklaan B.V., AZ Wormerveer (NL)

(72) Inventors: Helga Manson, AZ Wormerveer (NL); Krishnadath Bhaggan, AZ Wormerveer (NL)

(73) Assignee: Loders Croklaan B.V., AZ Wormerveer (NL)

(21) Appl. No.: 15/764,102

(22) PCT Filed: Sep. 15, 2016
(86) PCT No.: PCT/EP2016/071894

§ 371 Date: Mar. 28, 2018

(30) Foreign Application Priority Data
Sep. 29, 2015 (EP) 15187465.8

(51) Int. Cl. A23G 1/36; A23G 1/30; A23G 1/56; C11C 3/10

(52) U.S. Cl. CPC A23G 1/36; A23G 1/305; A23V 2002/00; C11C 3/10; A23G 1/56

(57) ABSTRACT

Disclosed is a chocolate spread or chocolate filling composition comprising one or more of the ingredients selected from hazelnut paste, cocoa butter, cocoa mass, cocoa powder, milk fat, milk powder, vanilla, and lecithin; 2% to 40% by weight of a fat composition; and 30% to 50% by weight of sugar, wherein the fat composition comprises at least 40% by weight of interesterified shea olein having an oleic acid content of at least 50% by weight and a stearic acid content of at least 25% by weight, based on the total C12 to C20 fatty acids present in the interesterified shea olein, and wherein the interesterified shea olein has a solid fat content of at least 10% at 10° C., at least 6% at 20° C., and at least 3% at 30° C.

### BACKGROUND

Spreads, such as hazelnut or chocolate spreads, are prepared by mixing fat such as palm fat with hazelnut paste or chocolate to form a sweet spread that can easily be applied to for instance a sandwich by using common cutlery such as a′spoon or a knife.

A problem with spreads is that the mixture of components may be unstable, leading to phase separation of the oil from the mixture (de-oiling/oil exudation). This leads to an unappealing appearance of the spread, and may also affect the taste and texture experienced when consuming the spread. Deoiling behavior may occur over time, and may be affected by the storage temperature of the spread.

Another problem that may occur with spreads is that the temperature tolerance for spreadability may be limited. Consumers may find it difficult to apply the spread at temperatures outside the appropriate temperature window. At temperatures below the suitable temperature range for spreadability, the spread is solid and excessive force is needed to apply the spread. Above the suitable temperature range, the spread becomes liquid and will insufficiently adhere to the cutlery (such as a knife) used to apply the spread to for instance a sandwich.

Another problem in spreads is that spreads, when stored in a refrigerator the spread can not be consumed immediately as the structure has become too hard to take out of the container by for instance a spoon or knife. This is referred to as the spoonability of the spread. Refrigerators are usually designed to cool products to a temperature under 10° C.

It is particularly difficult to prepare a chocolate spread that has a sufficient chocolate flavor. When low amounts of chocolate are added, the chocolate taste is not strong enough. However, at higher levels of chocolate, the mixture may become unstable and shows recrystallization behavior after extended storage. The formation of crystals at the surface gives the spread an unappealing appearance and may affect the taste and texture.

Although satisfactory chocolate spreads are commercially available, these spreads only show the desired properties over a limited temperature range.

It is an object of the invention to enable chocolate spreads that display desirable properties over a wider temperature range.

The present invention relates to a chocolate spread composition comprising one or more of the ingredients selected from hazelnut paste, cocoa butter, cocoa mass, cocoa powder, milk fat, milk powder, vanilla, and lecithin; 2% to 40% by weight of a fat composition; 30% to 50% by weight of sugar; wherein the fat composition comprises at least 40% by weight of interesterified shea olein and optionally up to 60% by weight of a liquid vegetable oil; wherein the interesterified shea olein has an oleic acid content of at least 50% by weight and a stearic acid content of at least 25% by weight, based on the total C12 to C20 fatty acids present in the interesterified shea olein, and wherein the interesterified shea olein has a solid fat content of at least 10% at 10° C., at least 6% at 20° C., and at least 3% at 30° C. The chocolate spread can also be used as a chocolate filling.

Preferably, the fat composition comprises at least 80%, preferably at least 90%, by weight of interesterified shea olein. More preferably, the fat composition comprises at least 99% by weight of interesterified shea olein and up to 1% by weight of a liquid oil. It is even more preferred if the composition comprises 100% by weight interesterified shea olein.

In a preferred embodiment, the liquid oil comprises soybean, sunflower and/or rapeseed oil, preferably rapeseed oil. Preferably, the liquid oil consists of rapeseed oil.

In another preferred embodiment, the spread comprises cocoa butter, cocoa mass and/or cocoa powder, wherein the amount of cocoa butter, cocoa mass and/or cocoa powder is at least 10% by weight of the spread, preferably at least 15% by weight.

It is advantageous if the chocolate spread composition is essentially free of nuts components other than cocoa butter, cocoa mass and/or cocoa powder.

Preferably, the chocolate spread composition comprises a combination of milk powder and lecithin.

In a preferred embodiment, the interesterified shea olein has a solid fat content in the range of from 10-20% at 10° C., from 6-16% at 20° C., and from 3-13% at 30° C. Solid fat contents mentioned herein are determined using NMR spectroscopy according to the IUPAC 2.150a method.

It is advantageous if the composition has a good spoonability using a dry metal spoon at temperatures in the range of 1-15° C., preferably in the range of 4-12° C.

Preferably, the spread does not show recrystallization after storage at 15° C. for at least one month, preferably after 3 months.

Preferably, the spread does not show oil exudation after storage at 15° C. for at least one month, preferably after 3 months.

The invention also relates to a method of preparation of a chocolate spread composition, comprising the step of mixing a fat composition with other chocolate spread ingredients; wherein the fat composition comprises at least 60% by weight of interesterified shea olein and optionally up to 40% by weight of a liquid vegetable oil; wherein the interesterified shea olein has an oleic acid content of at least 50% by weight and a stearic acid content of at least 25% by weight, based on the total C12 to C20 fatty acids present in the interesterified shea olein, and wherein the interesterified shea olein has a solid fat content of at least 10′% at 10° C., at least 6% at 20° C., and at least 3% at 30° C.

Preferably, the fat composition is mixed with one or more of the ingredients selected from hazelnut paste, cocoa butter, cocoa mass, cocoa powder, milk fat, milk powder, vanilla, and lecithin; sugar; and optional other ingredients.

The invention will now be further elucidated by the following non-limiting examples.

### EXAMPLES

### Example 1: Preparation of Fat Blends

### A: Interesterified Shea Olein

About 5000 gram of shea olein was chemically interesterified. The oil was heated to 110° C. and dried for 30 min at a pressure of about 50 mbar. To this dried oil was added sodium methoxide (0.10% w/w) and the mixture was stirred far 30 min at about 100 mbar. After this, the reaction was stopped by adding citric acid and washed with water afterwards until essentially free of soaps. The interesterified shea olein was further refined according to a standard refining procedure (bleaching and deodorization) for further use. The analytical results are shown in table 1 under fat blend A. Interesterified shea olein A (inShf) was blended with rapeseed oil (RP) to yield blends B and C. Analytical results are also shown in table 1. As a reference fat, the commercially available fully refined fat Durkex 102 was used, as obtained from Loders Croklaan BV, the Netherlands. This reference fat is based on a palm olein fraction, and is used in commercially available chocolate spreads. The analytical results are also shown in table 1.

### Example 2: Fat Blends Analytical Data

Solid Fat content (SFC) is determined using NMR spectroscopy according to the IUPAC 2.150a method. Solid fat contents at x ° C. are denoted as Nx. For example, a solid fat content at 20° C. is referred to as N20.

Fatty acid residue composition was determined using fatty acid methyl ester analysis (FAME) gas chromatography according to ISO 15304. Cx:y refers to a fatty acid having x carbon atoms and y double bonds; The extension ‘c’ refers to cis fatty acids and ‘t’ refers to trans fatty acids. Fatty acids are straight chain carboxylic acids having from 8 to 24 carbon atoms and optionally one or more double bonds.

The fatty acid compositions are characterized in the content of saturated fatty acids (SAFA), monounsaturated fatty acids (MUFA) and polyunsaturated fatty acids (PUFA). SAFA are fatty acids without unsaturated bonds, such as palmitic acid (C16:0) and oleic acid (C18:0). As defined herein, SAFA is the total of C120, C140, C16:0, C17:0, C18:0, C20:0, C22:0 C24:0. Mono unsaturated fatty acids (MUFA) are fatty acids having a single carbon-carbon double bond, which may be in either the cis or trans configuration. Total trans is the total amount of trans fatty acids.

The group of MUFA includes but is not restricted to palmitoleic acid (C16:1 cis) and oleic acid (C18:1 cis). As defined herein, MUFA is the total of C16:1 c/t, C18:1 c/t, C20:1 c/t, C22:1 c/t and C24:1 c/t; wherein c/t indicates the combined amounts of cis and trans fatty acids for that particular number of carbon atoms. Polyunsaturated fatty acids (PUFA) have more than one carbon-carbon double bond, such as two or three double bonds. SAFA, MUFA and PUFA values are calculated by adding up amounts of the respective compounds as determined through the FAME analysis.

Iodine value (IV) was calculated according to AOCS Cd 1c-85, based on the fatty acid composition, as determined using fatty acid methyl ester analysis (FAME) gas chromatography according to ISO 15304. IVFAME refers to the calculated iodine value.

Triglyceride composition was determined using gas chromatography according to ISO 23275. In the table the triglycerides are identified as 3-letter coded names according to the fatty acid residues, wherein A=Arachidoyl-, L=linoleoyl-, M=myristoyl-, P=palmitoyl, O=oleoyl-, St=Stearoyl-. For instance StOSt means 2-oleoyl-1,3-distearoylglyceride. SUMSOS refers to total SOS (S is stearic or palrnitic acid and O is oleic acid).

TABLE 1
Analysis results for fats used for recrystallization test

| | Example | | | |
|---|---|---|---|---|
| | | B | | |
| | A | 50/50 | C | Ref |
| | inSHf | inSHf/RP | 80/20 inSHf/RP | Durkex 102 |
| Solid Fat Content | | | | |
| US-N10 NMR | 14.1 | 7.8 | 8.9 | 11.3 |
| US-N15 NMR | 10.8 | 6.6 | 9 | 6.9 |
| US-N20 NMR | 9.3 | 4.1 | 7.7 | 4.5 |
| US-N25 NMR | 7.4 | 2.6 | 5.1 | 2.7 |
| US-N30 NMR | 5.3 | 2.1 | 3.7 | 1.2 |
| US-N35 NMR | 3.7 | 1.3 | 2.4 | 0 |
| FAME | | | | |
| C8:0 | 0 | 0 | 0 | 0 |
| C10:0 | 0 | 0 | 0 | 0 |
| C12:0 | 0 | 0 | 0.1 | 0.3 |
| C14:0 | 0 | 0.1 | 0.1 | 1 |
| C15:0 | 0 | 0 | 0 | 0 |
| C16:0 | 4.2 | 4.3 | 4.3 | 35.6 |
| C16:1T | 0 | 0 | 0 | 0 |
| C16:1C | 0.1 | 0.2 | 0.1 | 0.3 |
| C17:0 | 0.1 | 0.1 | 0.1 | 0.1 |
| C18:0 | 29.7 | 15.1 | 23.7 | 4 |
| C18:1 | 54.9 | 59.2 | 56.5 | 44 |
| C18:1T | 0.1 | 0 | 0.1 | 0.1 |
| C18:1C | 54.9 | 59.2 | 56.5 | 44 |
| C18:2 | 8.5 | 13.9 | 10.7 | 13.5 |
| C18:2T | 0.1 | 0.1 | 0.1 | 0.2 |
| C18:2C | 8.3 | 13.8 | 10.5 | 13.3 |
| C18:3 | 0.3 | 4.8 | 2.2 | 0.4 |
| C18:3T | 0.1 | 0.6 | 0.3 | 0.1 |
| C18:3C | 0.1 | 4.2 | 1.9 | 0.3 |
| C20:0 | 1.3 | 0.9 | 1.1 | 0.4 |
| C20:1C | 0.5 | 0.7 | 0.5 | 0.2 |
| C20:2C | 0 | 0 | 0 | 0 |
| C22:0 | 0.1 | 0.2 | 0.2 | 0.1 |
| C22:1 | 0 | 0 | 0 | 0 |
| C22:1T | 0 | 0 | 0 | 0 |
| C22:1C | 0 | 0 | 0 | 0 |
| C24:0 | 0.1 | 0.1 | 0.1 | 0.1 |
| C24:1C | 0 | 0.1 | 0 | 0 |
| Others | 0.2 | 0.3 | 0.3 | 0.1 |
| SAFA | 35.5 | 20.8 | 29.6 | 41.6 |
| MUFA | 55.5 | 60.2 | 57.3 | 44.4 |
| PUFA | 8.7 | 18.7 | 12.9 | 13.9 |
| IVFAME | 63.1 | 88.4 | 73.4 | 62.6 |
| Total Trans | 0.3 | 0.8 | 0.5 | 0.4 |
| SAFA g/100 g fat | 33.8 | 19.8 | 28.1 | 39.5 |
| MUFA g/100 g fat | 52.7 | 57.2 | 54.4 | 42.2 |
| PUFA g/100 g fat | 8.3 | 17.8 | 12.2 | 13.2 |
| Triglycerides | | | | |
| MPP | 0 | 0 | 0 | 0.2 |
| MOM | 0 | 0 | 0.2 | 0.1 |
| PPP | 0 | 0.1 | 0.2 | 2.4 |
| MOP | 0 | 0.7 | 2 | 1.6 |
| MLP | 0 | 0 | 0.6 | 0.6 |
| PPSt | 0.2 | 0.1 | 0.3 | 0.5 |
| POP | 0.5 | 0.1 | 0.3 | 16.3 |
| PLP | 0.5 | 0.3 | 0.5 | 11.5 |
| C50 Others | 1.1 | 0.2 | 0.9 | 1.1 |
| PStSt | 2.1 | 0.6 | 1 | 0.1 |
| POSt | 4.5 | 2.1 | 4 | 2.6 |
| POO | 4.4 | 5.4 | 4.7 | 31.1 |
| PLSt | 0.7 | 0.6 | 0.7 | 2.4 |
| PLO | 1.4 | 3 | 1.9 | 13.6 |
| PLL | 0.3 | 1.4 | 0.2 | 2.8 |
| StStSt | 3 | 1.7 | 2.3 | 0 |
| StOSt | 16.8 | 9.2 | 13.5 | 1.2 |
| StOO | 27.4 | 15.6 | 21.4 | 3.2 |
| StLSt | 1.8 | 0.8 | 1.5 | 0.2 |
| OOO | 16.4 | 24.7 | 18.2 | 4.1 |
| StLO | 7.5 | 5.9 | 6.9 | 1.6 |
| OLO | 6.7 | 14.8 | 9.4 | 1.9 |
| StLL | 0.6 | 0.3 | 0.5 | 0.3 |
| OLL | 1.2 | 6.1 | 2.5 | 0.4 |
| AStSt | 0 | 1.9 | 1.1 | 0 |
| AOSt | 1.1 | 2.5 | 1.1 | 0 |
| AOO | 1.3 | 0.8 | 0.8 | 0.2 |
| ALSt | 0.1 | 0 | 0.4 | 0 |
| Others | 0.4 | 1.3 | 3 | 0.1 |
| SUMSOS | 21.8 | 11.4 | 17.8 | 20.1 |

### Example 3: Chocolate Spreads

A chocolate spread was prepared by mixing the following ingredients using a ball mill at 240 rpm for 45 minutes. Fat blend B was used. For a reference spread, the fat blend was replaced by a standard chocolate spread fat, Durkex 102 obtained from Loders Croklaan BV, Wormerveer, the Netherlands.

| Ingredient | Percentage |
|---|---|
| Sugar | 40 |
| Fat blend | 35 |
| Milk chocolate (Milka) | 15 |
| Skimmed milk powder | 5 |
| Cocoa powder 74 | 5 |
| Lecithin | 0.4 |

### Example 4: Chocolate Spreads with Hazelnut Paste

A chocolate spread with hazelnut paste was prepared by mixing the following ingredients using a ball mill at 240 rpm for 45 min.

| Ingredient | Percentage |
|---|---|
| Sugar | 48 |
| Fat blend | 22 |
| Hazelnut paste 100% | 13 |
| Skimmed milk powder | 9 |
| Cocoa powder alkalised | 8 |
| Lecithin | 0.4 |

The chocolate spreads were prepared using the fat blends according to table I. As a reference, fat blend Durkex 102 was used. Chocolate spreads are summarized in table 2.

TABLE 2
Chocolate spreads according to recipes as
described in examples 3 and 4.

| | Fat blend |
|---|---|
| Chocolate spread (ex 3) | |
| 1 | B |
| 2 | Ref |
| Chocolate spread + Hazelnut paste (ex 4) | |
| 3 | A |
| 4 | B |
| 5 | C |
| 6 | Ref |

### Example 5: Storage Trials: Recrystallization

The spreads prepared according to example 3 where deposited at 50° C. in containers and cooled in a static cooling cabinet (12° C.) for at least 20 minutes. After the initial cooling, the spreads were stored at different temperatures for further evaluation. The spreads were stored at temperatures of 15° C., 20° C., 25° C., 30° C., as well as under temperature cycling conditions cycling between 15° C. 12 hours and 25° C. for 12 hours and evaluated immediately after 1 night at ambient temperature (20° C.) and after 1, 2 or 3 weeks, and after 1, 2 or 3 months. Recrystallization results are summarized in table 3.

The samples were evaluated for the following properties: Appearance (re-crystallization, oil exudation and gloss) and sensory evaluation.

TABLE 3
recrystallization results.

| | Fat blend | Recrystallization |
|---|---|---|
| Chocolate spread (ex 3) | | |
| 1 | B | no |
| 2 | Ref | yes |
| Chocolate spread + hazelnut (ex 4) | | |
| 4 | B | no |
| 6 | Ref | no |

For the chocolate spread based on fat blend B, no re-crystallization occurred, whereas recrystallization was clearly visible for the other chocolate spreads including the chocolate/hazelnut spreads. Samples where recrystallization had occurred showed crystals on the surface, including the chocolate/hazelnut spread using the same fat blend as the chocolate spread according to example 2.

These data show that fat blend B offers a solution for circumventing recrystallization in all-chocolate spreads without added hazelnut paste according to example 3.

### Temperature Tolerance

The spreads 4-6 according to example 4 were stored at 50° C. in containers and cooled in a static cooling cabinet (12° C.) for at least 20 minutes. Subsequently, the containers were stored at different temperatures for further evaluation at fridge temperature (approx. 7° C.), 20° C., 25° C., 40° C. with cycling: 12 hours 20° C./12 hours 40° C. The samples were evaluated initially after 1 night, after 1 week and after 1 month.

### Spoonability

The samples were, further tested for spoonability after storage for one week or one month at 7° C. The samples were investigated qualitatively by attempting to scoop a spoon full of chocolate spread from a container directly after taking the container from the refrigerator, using a dry metal spoon at ambient temperature (20° C.). A new spoon at ambient temperature was used for each sample to rule out the influence of heating by hand warmth. As a reference, a chocolate spread based on Durkex 102 was used. Results are shown in tables 4a and 4b.

TABLE 4a
Spoonability after 1 week at 7° C.

| Chocolate spread | Fat composition | Spoonability |
|---|---|---|
| 3 | A | Hard, not spoonable |
| 4 | B | Softer than 3, spoonable |
| 5 | C | Harder than 4, spoonable |
| 6 | Ref | Hard, not spoonable |

TABLE 4b
Spoonability after 1 month at 7° C.

| Chocolate spread | Fat composition | Spoonability |
|---|---|---|
| 3 | A | Hard, not spoonable |
| 4 | B | Spoonable |
| 5 | C | Hard, not spoonable |
| 6 | Ref | Hard, not spoonable |

The appearance was assessed after one day, one week and one month, as shown in the following tables. Appearance was evaluated for oil exudation, re-crystallization, gloss and contraction. Gloss is indicated by a gloss factor ranging from 1-5, wherein 1 is matte (no gloss) and 5 is very glossy. Deoiling/oil exudation is indicated with the code OE. A grainy texture is indicated with the code GR. Results are shown in tables 5a, 5b and 5c.

TABLE 5a
Gloss after one day

| Sample | Fat | 7° C. | 20° C. | 25° C. | 40° C. | 20/40° C. |
|---|---|---|---|---|---|---|
| 3 | A | 1/2 | 2 | 2 | 5 | 5 |
| 4 | B | 2/3 | 3 | 3 | 5 | 5 |
| 5 | C | 2 | 2/3 | 2/3 | 5 | 5 |
| 6 | Ref | 3/4 | 4 | 4 | 5 | 5 |

TABLE 5b
Gloss after one week

| Sample | Fat | 7° C. | 20° C. | 25° C. | 40° C. | 20/40° C. |
|---|---|---|---|---|---|---|
| 3 | A | 1 | 1/2 | 2 | 5 | 5 |
| 4 | B | 1 | 3 | 3 | 5 OE | 5 |
| 5 | C | 1 | 2 | 2/3 | 5 OE | 5 |
| 6 | Ref | 1 | 4 | 4 | OE | 5 |

TABLE 5c
Gloss after one month

| Sample | Fat | 7° C. | 20° C. | 25° C. | 40° C. | 20/40° C. |
|---|---|---|---|---|---|---|
| 3 | A | 1 | 1/2 | 2 | 5 | 5 OE |
| 4 | B | 1 | 3/4 | 3 | OE | 5 |
| 5 | C | 1 | 2 | 2/3 | OE | 5 |
| 6 | Ref | 1 | 4 | 4 | OE | 5 OE |

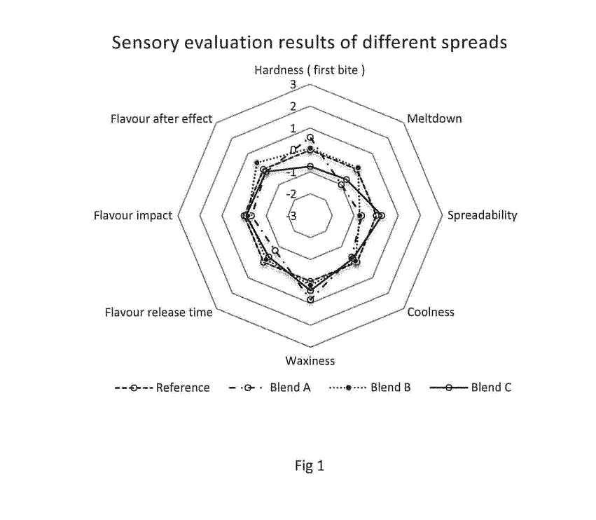

After 1 month of storage, samples 3-6 were further subjected to relative sensory evaluation by a trained test panel, with the results shown in the diagram in FIG. 1. The samples were evaluated for relative Hardness (first bite), Meltdown, Spreadability, Coolness, Waxiness, Flavour release time, Flavour impact and Flavour after effect.

1. Chocolate spread and/or filling composition comprising:
one or more ingredients selected from hazelnut paste, cocoa butter, cocoa mass, cocoa powder, milk fat, milk powder, vanilla, and lecithin;
2% to 40% by weight of a fat composition; and
30% to 50% by weight of sugar,
wherein the fat composition comprises at least 40% by weight of interesterified shea olein and optionally up to 60% by weight of a liquid vegetable oil,
wherein the interesterified shea olein has
an oleic acid content of at least 50% by weight and
a stearic acid content of at least 25% by weight, based on the total C12 to C20 fatty acids present in the interesterified shea olein, and
wherein the interesterified shea olein has a solid fat content of at least 10% at 10° C., at least 6% at 20° C., and at least 3% at 30° C.

2. Chocolate spread according to claim 1, wherein the fat composition comprises at least 80%, by weight of interesterified shea olein.

3. Chocolate spread according to claim 1, wherein the fat composition comprises at least 99% by weight of interesterified shea olein and up to 1% by weight of a liquid oil.

4. Chocolate spread according to claim 1, wherein the composition comprises 100% by weight interesterified shea olein.

5. Chocolate spread according to claim 1, wherein the liquid oil comprises soybean, sunflower and/or rapeseed oil.

6. Chocolate spread according to claim 5 where in the liquid oil consists of rapeseed oil.

7. Chocolate spread composition according to claim 1, wherein the spread comprises cocoa butter, cocoa mass and/or cocoa powder, wherein the amount of cocoa butter, cocoa mass and/or cocoa powder is at least 10% by weight of the spread.

8. Chocolate spread composition according to claim 7, wherein the chocolate spread composition is essentially free of nuts components other than cocoa butter, cocoa mass and/or cocoa powder.

9. Chocolate spread composition according to claim 1, wherein the chocolate spread composition comprises a combination of milk powder and lecithin.

10. Chocolate spread composition according to claim 1, wherein the interesterified shea olein has a solid fat content in the range of from 10-20% at 10° C., from 6-16% at 20° C., and from 3-13% at 30° C.

11. Chocolate spread composition according to claim 1, wherein the composition is spoonable using a dry metal spoon at temperatures in the range of 1-15° C.

12. Chocolate spread composition according to claim 1, wherein the spread does not show recrystallization after storage at 15° C. for at least one month.

13. Chocolate spread composition according to claim 1, wherein the spread does not show oil exudation after storage at 40° C. for at least one month.

14. Method of preparing a chocolate spread composition and/or confectionery filling, comprising the step of mixing a fat composition with other chocolate spread ingredients,
wherein the fat composition comprises at least 40% by weight of interesterified shea olein and optionally up to 60% by weight of a liquid vegetable oil,
wherein the interesterified shea olein has
an oleic acid content of at least 50% by weight and
a stearic acid content of at least 25% by weight, based on the total C12 to C20 fatty acids present in the interesterified shea olein, and
wherein the interesterified shea olein has a solid fat content of at least 10% at 10° C., at least 6% at 20° C., and at least 3% at 30° C.

15. Method according to claim 14, wherein the fat composition is mixed with
one or more ingredients selected from hazelnut paste, cocoa butter, cocoa mass, cocoa powder, milk fat, milk powder, vanilla, and lecithin;
sugar; and
optionally other ingredients.
